(19) United States
(12) Patent Application Publication
(10) Pub. No.: US 2013/0126565 A1
(43) Pub. Date: May 23, 2013

(54) DEVICE HOLDER APPARATUS WITH CLIP AND METHOD OF FORMING APPARATUS

(71) Applicant: Ramin Rostami, Calabasas, CA (US)

(72) Inventor: Ramin Rostami, Calabasas, CA (US)

(21) Appl. No.: 13/300,187

(22) Filed: Nov. 18, 2011

(51) Int. Cl. A45F 5/00; B23P 17/04

(52) U.S. Cl. 224/191; 29/428

(57) ABSTRACT

Embodiments of a device holder apparatus with clip and methods of forming same where the device holder apparatus may include a device conforming body rotatably and ratchetly coupled to a clip assembly via a locking washer assembly. Other embodiments may be described and claimed.

### TECHNICAL FIELD

Various embodiments described herein relate to device holder apparatus with clip.

### BACKGROUND INFORMATION

It may be desirable to form a device holder apparatus with integral clip where the clip is coupled to the holder without screws or adhesives. The present invention provides such a device holder apparatus with clip and method of forming same.

### BRIEF DESCRIPTION OF THE DRAWINGS

FIG. 1A is an isometric, exploded diagram of a device holder apparatus with clip according to various embodiments.

FIG. 1B is an isometric, diagram of a device holder apparatus with clip according to various embodiments.

FIG. 1C is a side diagram of a device holder apparatus with clip according to various embodiments.

FIG. 1D is a back diagram of a device holder apparatus with clip according to various embodiments.

FIG. 1E is a top diagram of a device holder apparatus with clip according to various embodiments.

FIG. 1F is a bottom diagram of a device holder apparatus with clip according to various embodiments.

FIG. 1H is a cross-sectional diagram of device holder apparatus with clip taken from top to bottom along a side view according to various embodiments.

FIG. 1A is an isometric, exploded diagram of a device holder apparatus with clip according to various embodiments.

FIG. 2A is an isometric, diagram of a device holder body according to various embodiments.

FIG. 2B is an partial, front diagram of a device holder body according to various embodiments.

FIG. 2C is a back diagram of a device holder body according to various embodiments.

FIG. 3A is an isometric diagram of a locking washer according to various embodiments.

FIG. 3B is a back diagram of a locking washer according to various embodiments.

FIG. 3C is a top diagram of a locking washer according to various embodiments.

FIG. 4 is an isometric diagram of a clip according to various embodiments.

FIG. 5A is an isometric diagram of a clip back according to various embodiments.

FIG. 5B is a back diagram of a clip back according to various embodiments.

FIG. 6 is an isometric diagram of a ratcheting disc according to various embodiments.

FIG. 7 is an isometric diagram of a device clip according to various embodiments.

FIG. 8A is an isometric diagram of a clip spring according to various embodiments.

FIG. 8B is an isometric diagram of a device clip spring and pin according to various embodiments.

FIG. 9A is an isometric diagram of a lock support according to various embodiments.

FIG. 9B is a top diagram of a lock support according to various embodiments.

FIG. 10 is an isometric diagram of another clip according to various embodiments.

FIG. 11 is a flow diagram illustrating several methods according to various embodiments.

### DETAILED DESCRIPTION

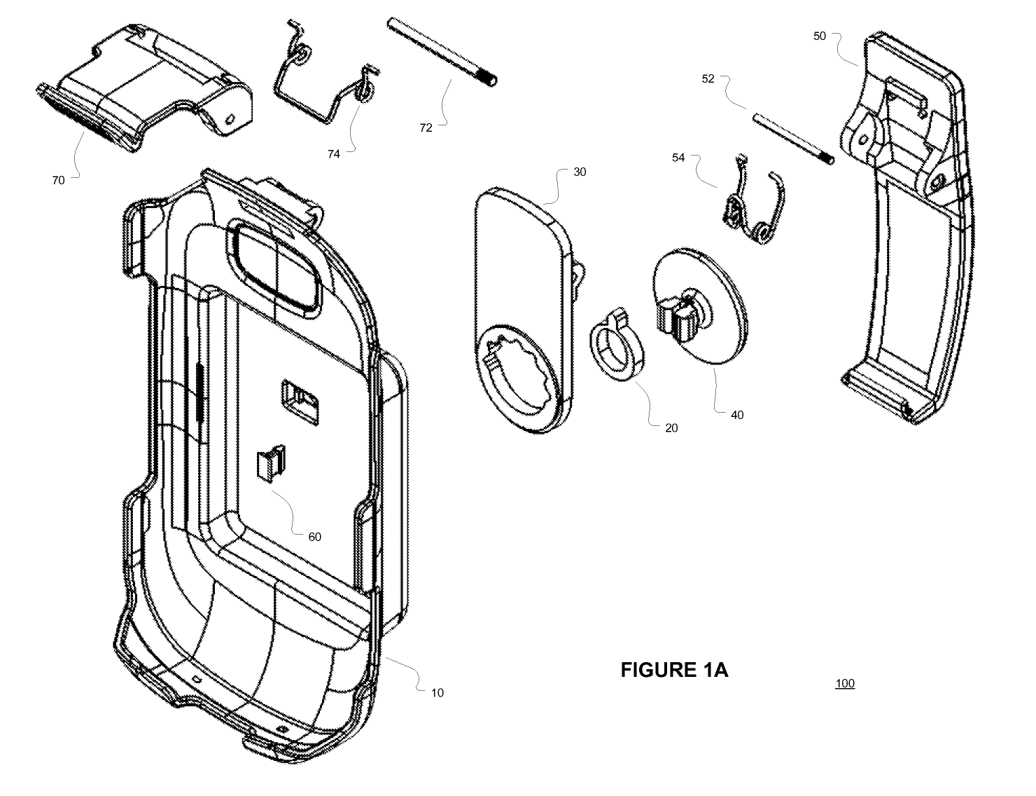

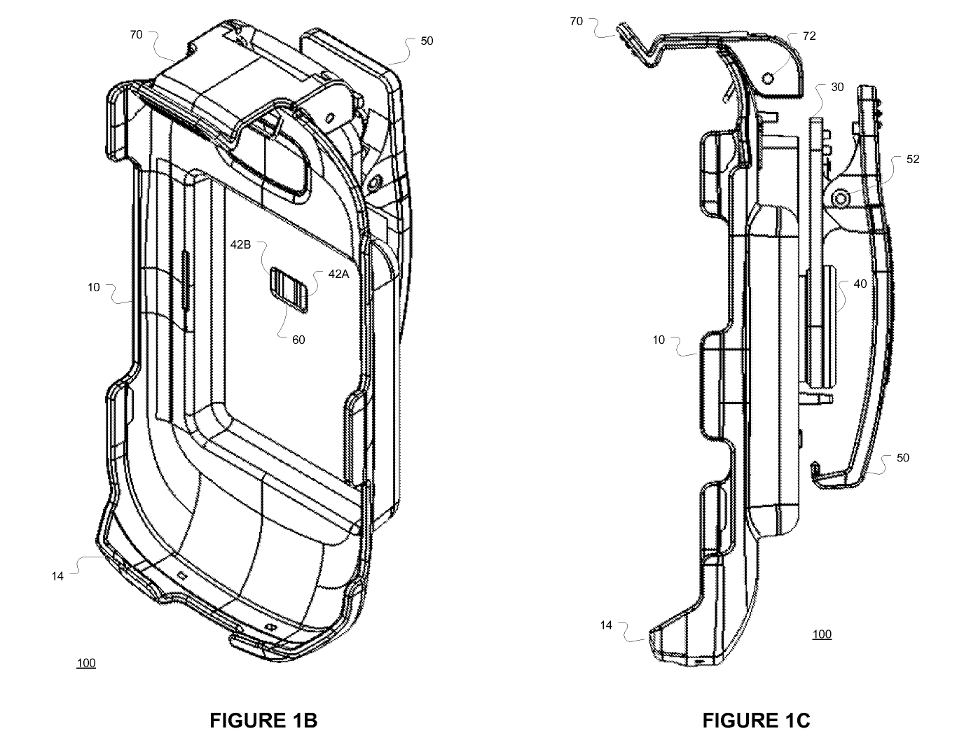

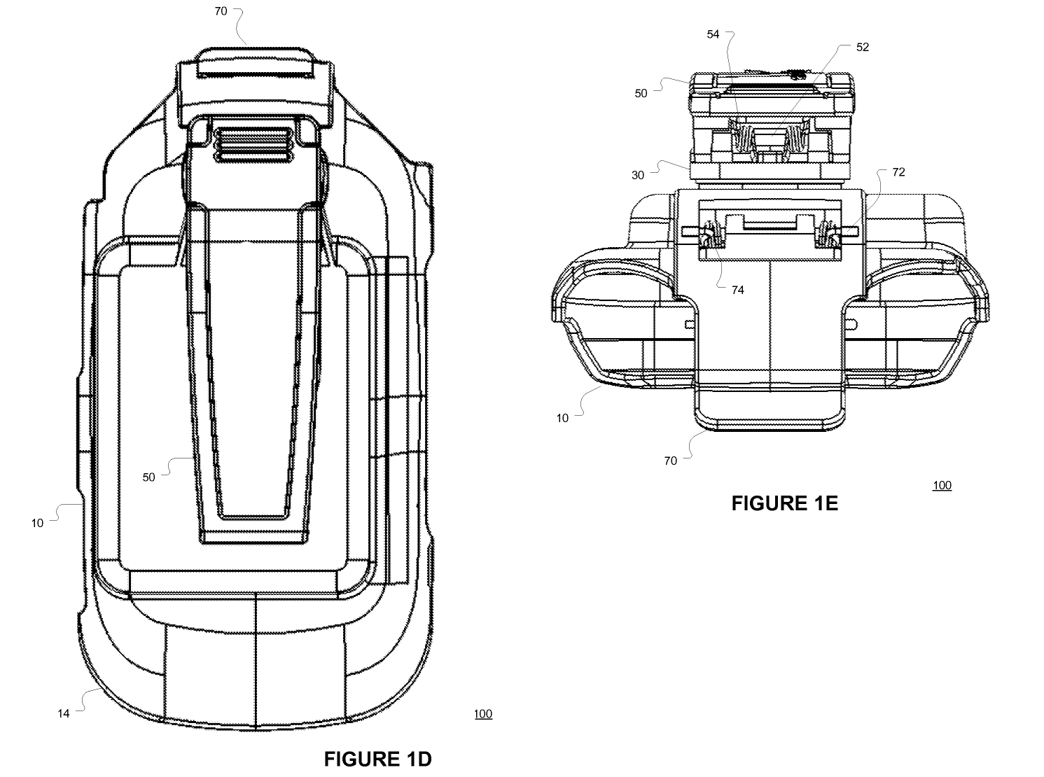

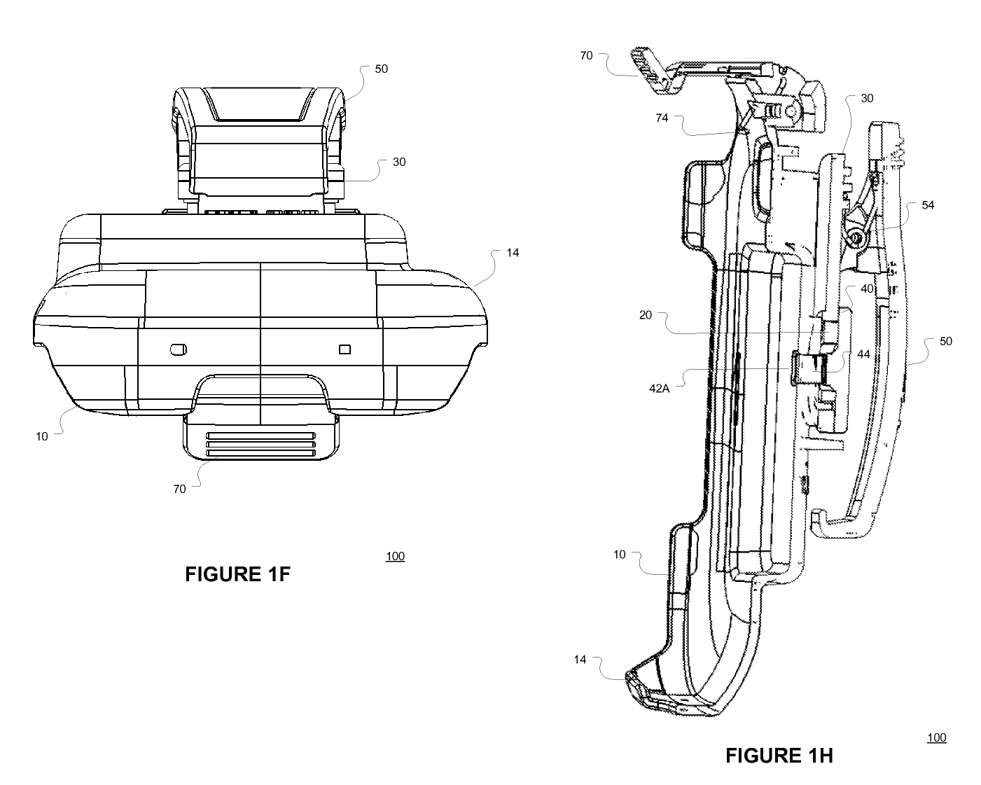

FIG. 1A is an isometric, exploded diagram of a device holder apparatus with clip (DHAC) 100 according to various embodiments. The DHAC 100 includes a main device conforming body 10, a main clip 50, and a device retention clip 70. In an embodiment, a main clip assembly 90 (shown in FIG. 4) may include a main clip 50 coupled to a clip back 30 via a pin 52 and a spring 54. The device retention clip 70 may be coupled to the main device conforming body 10 via a pin 72 and a spring 74. The main clip assembly 90 may be coupled to the conforming body 10 via a locking washer 40. The DHAC 100 may also include a ratcheting disc 20 where the disc 20 is seated in the clip back 30 and held in place via the locking washer 40 and conforming body 10. The DHAC 100 may also include a lock support 60 that may be inserted thought the conforming body 10 into the locking washer 40.

FIG. 1B is an isometric, diagram of the DHAC 100 according to various embodiments. In FIG. 1B, the main clip assembly 90 is coupled to the main conforming body 10 via the locking washer 40 and the lock support 60. The device retention clip 70 is coupled to the main conforming body 10 via the clip pin 72 and clip spring 74. FIG. 1C is a side diagram of a DHAC 100 according to various embodiments. As shown in FIG. 1C and FIG. 1H, the locking washer 40 extends from the clip back 30 the device conforming body 10. The device conforming body 10 shape may vary as a function of the device to be held adjacent or within the body 10. In an embodiment the device clip 70 may be omitted as a function of the device shape and one or more lips 14 in the main conforming body 10.

FIG. 1D is a back diagram, FIG. 1E is a top diagram, and FIG. 1F is a bottom diagram of a DHAC 100 according to various embodiments. FIG. 1H is a cross-sectional diagram of the DHAC 100 taken from top to bottom along a side view according to various embodiments. As shown these figures the device clip 70 may be coupled to the conforming body 10 at an end via a pin 72 and spring 74. The spring 74 may provide a restoring force to hold a device adjacent or within the conforming body 10. Similarly the main clip 50 is coupled to the clip back 30 via the pin 52 and spring 54. The spring 54 may also provide a restoring force to hold a section or end of the main clip 50 adjacent or near the clip back 30. FIG. 1H also shows that ratcheting disc 20 may located centrally and on locking washer 40 shaft 44.

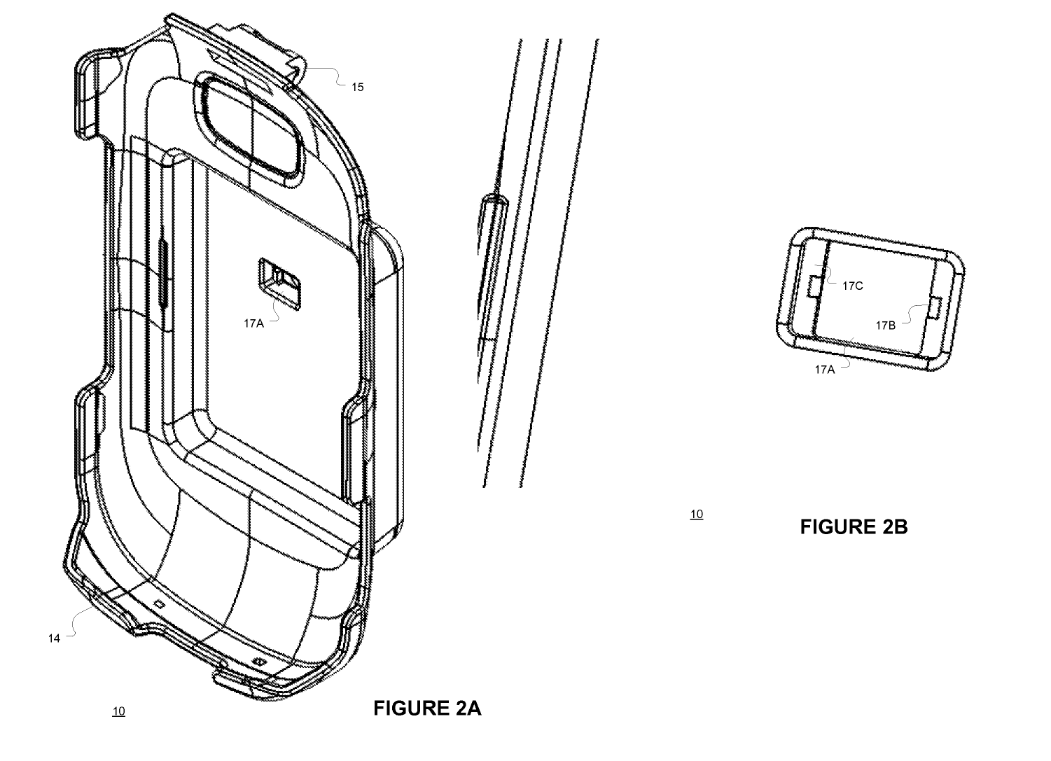

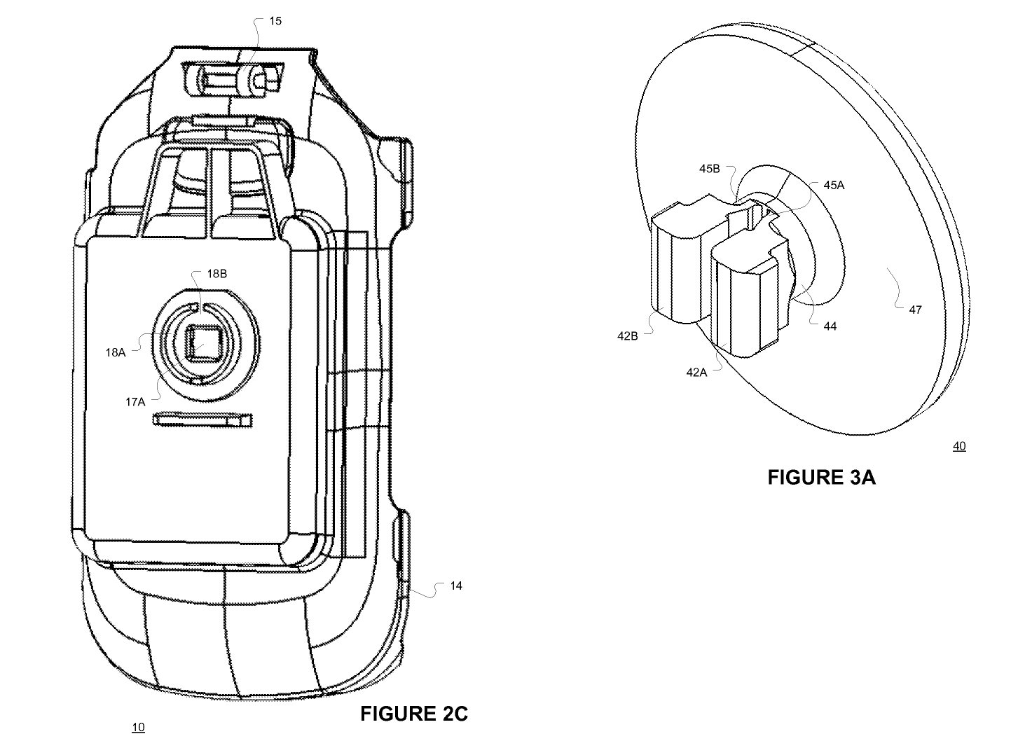

FIG. 2A is an isometric, diagram of a main device conforming body 10 according to various embodiments and FIG. 2B is a partial, front diagram of the main device conforming body 10 according to various embodiments. As shown in FIG. 2A and 2B, the main device conforming body 10 may include a device clip interface 15. The device clip interface 15 may engage the pin 72 to couple the device clip 70 to the conforming body 10. As also shown in FIG. 2A and FIG. 2B, the conforming body 10 may include a locking washer opening 17A. As shown in FIG. 2B the locking washer opening 17A may one or more tab offsets 17B, 17C. FIG. 11 is a flow diagram illustrating several methods 110 according to various embodiments.

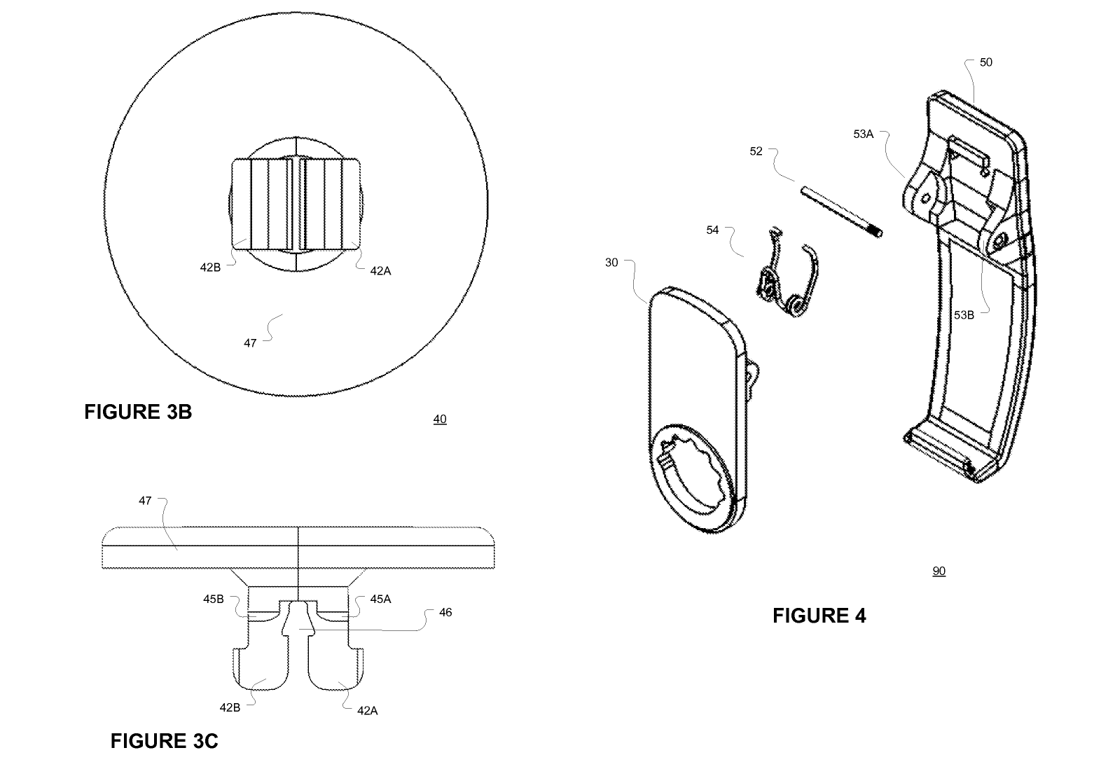

The method 110 may be employed to couple the main clip to the conforming body 10 via the locking washer 40. In operation the locking washer 40 deflectable tabs 42A, 42B may be inserted into the clip back plate 30 opening 34A (activity 112). Then the locking washer 40 deflectable tabs 42A, 42B may be inserted through the conforming body 10 opening 17A (activity 114). In an embodiment, the locking washer 40 deflectable tabs 42A, 42B may be inserted through the conforming body 10 opening 17A until the tabs 42A, 42B are deflected inward by the opening 17A tabs 17B, 17C and then engage the locking washer 40 deflectable arms (45A, 45B—FIG. 3C) (activity 116).

As this point the locking washing 40 may securely couple the clip back plate 30 and correspondingly the main clip assembly 90 to the conforming body 10. In an embodiment, the locking washing 40 may securely and rotatably couple the clip back plate 30 and correspondingly the main clip assembly 90 to the conforming body 10. In a further embodiment, the locking washing 40 may securely and partially rotatably and ratchetly couple the clip back plate 30 and correspondingly the main clip assembly 90 to the conforming body 10. A lock support 60 may be inserted between the locking washer 40 deflectable tabs 42A, 42B and deflectable arms 45A, 45B and securely engage and mate with a shaped cavity 46 (shown in FIG. 3C) (activity 118). The lock support 60 insertion may strengthen the locking washer 40 engagement to the conforming body 10.

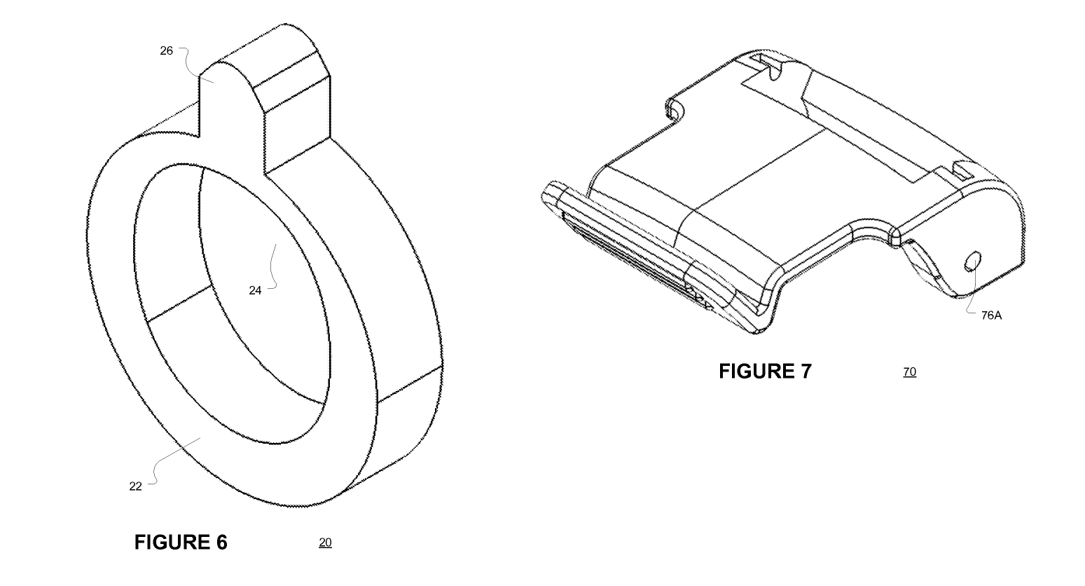

FIG. 2C is a back diagram of a main device conforming body 10 according to various embodiments. In an embodiment the conforming body 10 may include a partial ring 18A with an opening 18B. The partial ring 18A may engage the ratcheting disc 20 shown in FIG. 6. FIG. 3A is an isometric diagram, FIG. 3B is a back diagram, and FIG. 3C is a top diagram of a locking washer 40 according to various embodiments. As shown in FIG. 3A, 3B, and 3C, the locking washer 40 may include one or more deflectable arms 45A, 45B, each arm 45A, 45B including a deflectable tab 42B, 42A. The deflectable arms 45A, 45B may be coupled to the locking washer main circular, flat body 47 via a shaft 44. In an embodiment the compressible width of the deflectable tabs 42A, 42B may be smaller than the opening 17A formed by the tabs 17B, 17C and wider than same when decompressed.

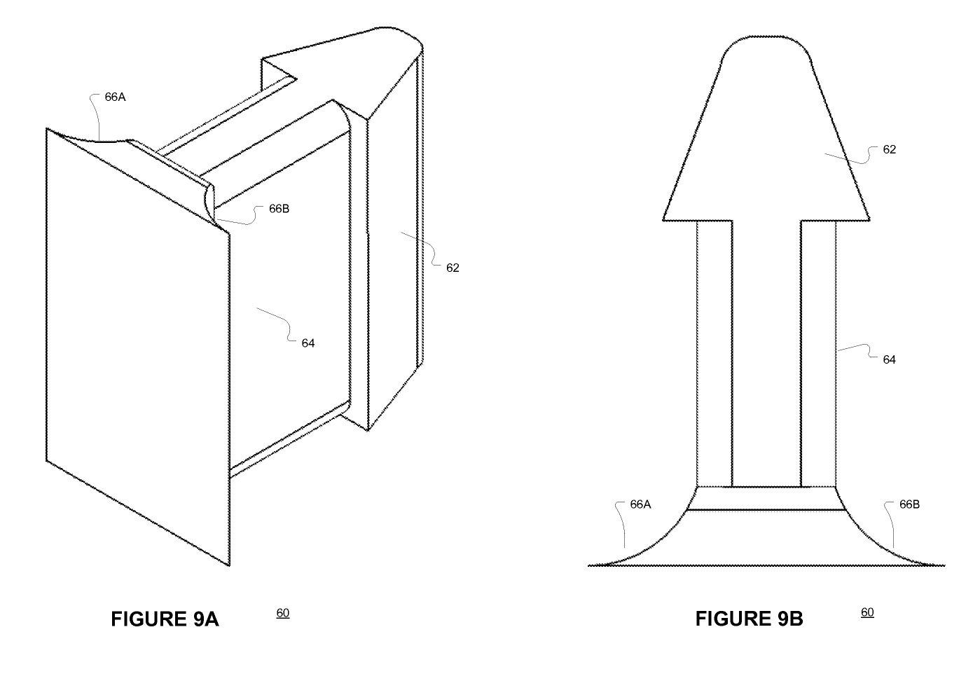

As shown in FIG. 3C, the locking washer 40 may include a shaped cavity 46. The shaped cavity 46 may be formed by the deflectable arms 45A, 45B. As noted above the shaped cavity 46 may be complementary in shape to the lock support 60 shown in FIG. 9A, 9B. The lock support 60 may also include complementary concave sections 66A, 66B that mate with the convex deflectable tabs 42A, 42B so the lock support rests somewhat flush with the conforming body 10 surface near or about the opening 17A.

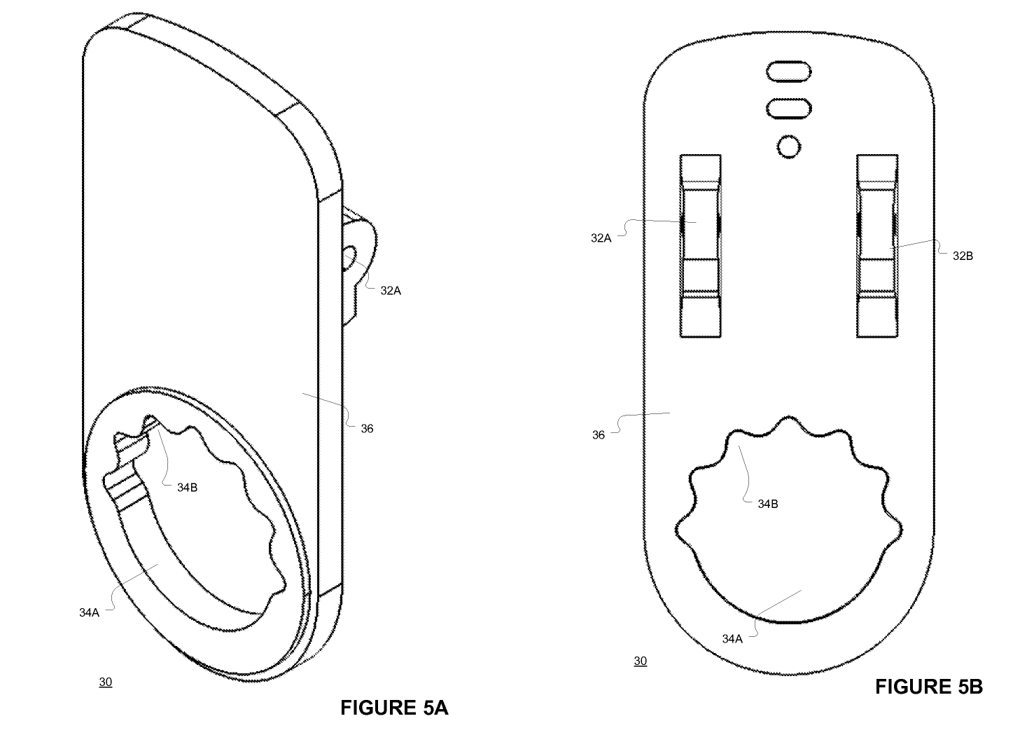

FIG. 5A is an isometric diagram and FIG. 5B is a back diagram of a clip back-plate 30 according to various embodiments. As shown in FIG. 5A, 5B, the clip back-plate 30 may include an opening 34A, main body 36, and pin slots 32A, 32B. In an embodiment the opening 34A may include one or more tabs 34B. The tabs 34B may be complementary in shape to the ratcheting disc 20 notch tab 26. In operation the ratcheting disc 20 may ratchetly limit the rotation of the clip back-plate 30 relative to the conforming body 10.

FIG. 6 is an isometric diagram of a ratcheting disc 20 according to various embodiments. As shown in FIG. 6 the ratcheting disc 20 may include a circular ring 22 with open center section 24 and tab 26. The center section 24 may be shaped to engage the locking washer 40 arm shaft 44 arms 45A, 45B to prevent rotation of the ratcheting disc about the locking washer 40 shaft 44. Accordingly when assembled only the clip back 30 via the opening 34A and tabs 34B may ratchetly rotate about the locking washer 40 shaft 44. The clip back 30 opening 34A and tabs 34B engagement with the ratcheting disc 20 tab 22 may limit the clip 30 rotation range relative to the device conforming body 10.

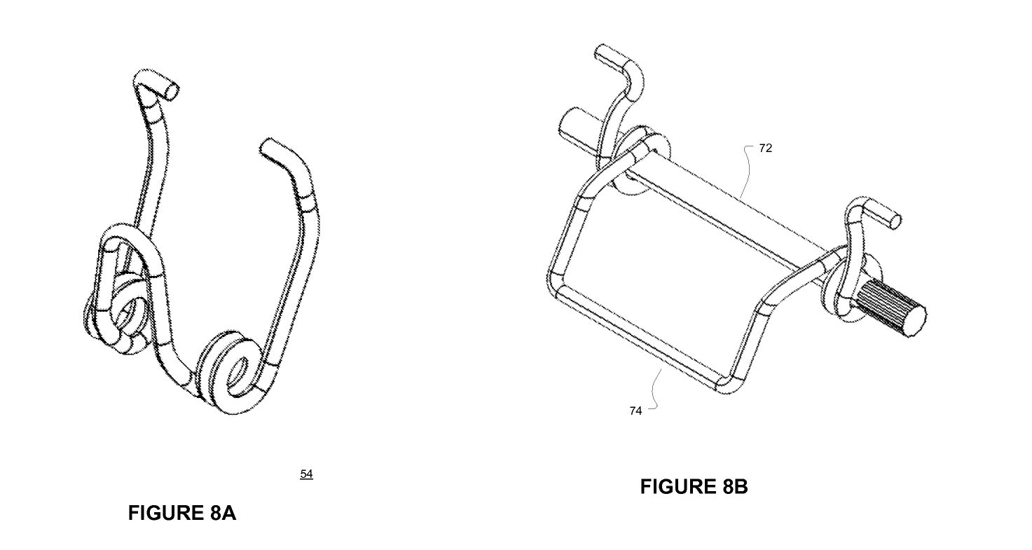

As shown the tab 26 may extend radially from the ring 22 center 24. FIG. 7 is an isometric diagram of a device clip 70 according to various embodiments. FIG. 8A is an isometric diagram of a main clip spring 54 according to various embodiments. FIG. 8B is an isometric diagram of a device clip 70 spring 74 and pin 72 according to various embodiments. As described above the pin 72 and spring 74 may be used to engage rotatably engage the device clip 70 to the conforming body 10 end clip interface 15.

FIG. 9A is an isometric diagram and FIG. 9B is a top diagram of a lock support of a lock support 60 according to various embodiments. In an embodiment the lock support tip 62 shape is complementary to the locking washer 40 cavity 46. In addition, the lock support tip 62 curved and increased in width from the distal end to enable the insertion of the support tip 62 between the deflectable tabs 42A, 42B and deflectable arms 45A, 45B of the locking washer 40. Further, the lock support 60 may include complementary arms 66A, 66B coupled to the shaped end 62 via a extension 64. As noted the complementary arms 66A, 66B may enable the locking support 60 to be substantially flush with the conforming body 10 surface near the opening 17A upon the lock support 60 engagement with the locking washer 40.

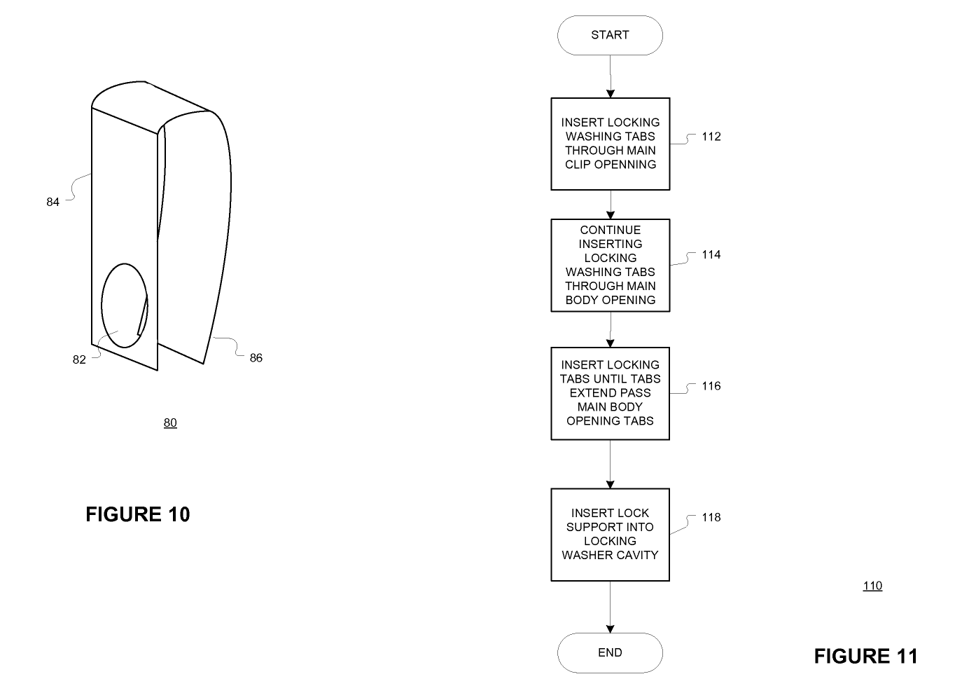

It is noted that other main clip assemblies 90 may be used in conjunction with the conforming body 10 and locking washer 40. FIG. 10 is an isometric diagram of another main clip assembly 80 according to various embodiments. The clip assembly 80 may include a back 84 with an opening 82 and a curved, deflectable front 86. The opening 82 may be sized to enable the insertion of the locking washer deflectable arms 45A, 45B and tabs 42A, 42B. The main clip assembly 80 may be formed of any deflectable material including a polymer or metal. The conforming body 10, device clip 70, clip back-plate 30, main clip 50, ratcheting disc 20, pins 72 and 52, and locking washing 40 may formed of any material having a desired level of rigidity including a polymer or metal. In addition, one or more decorative materials including man-make and natural materials including woven polymers, leather, silk, or other natural materials or skins may be coupled to one or more surfaces of the conforming body 10, device clip 70, clip back-plate 30, main clip 50, ratcheting disc 20, and locking washing 40. The addition materials may be coupled using a mechanical or adhesive. The springs 54, 74 may be formed of any deflectable material including a polymer or metal.

The conforming body 10 may engage any device including cellular telephones, personal computers (e.g., laptop computers, handheld computers, tablet computers, etc.), radios, video players, audio players (e.g., mp3 players), medical devices (e.g., heart monitor, blood pressure monitor, etc.) and others.

It may be possible to execute the activities described herein in an order other than the order described. Various activities described with respect to the methods identified herein can be executed in repetitive, serial, or parallel fashion. A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A device holder apparatus for an electronic device, the apparatus comprising:
a device conforming body, the body conformable to at least a portion of an electronic device to hold the electronic device;
a clip assembly for clipping to a desired location;
a locking washer assembly for rotatably and ratchetly coupling the clip assembly to the device conforming body, the locking washing assembly including:
a locking washer with two, separate deflectable arms, the separated arms forming a shaped cavity therebetween; and
a locking support having an extension having a protrusion formed in relief of the lock washer shaped cavity, the lock support securely inserted into the locking washer shaped cavity to securely retain the rotatably and ratchetly coupling between the clip assembly and the device conforming body.

2. The device holder apparatus of claim 1, wherein the locking washer assembly further includes a ratchet ring coupled over and to the locking washer two, separate deflectable arms, the ratchet ring including a protrusion.

3. The device holder apparatus of claim 2, wherein the clip assembly includes a clip back adjacent the device conforming body when coupled to the device conforming body by the locking washer assembly, the clip back including an opening enabling the passage of the locking washer arms and ratchet ring, and the clip back opening including a plurality of tabs configured to releasably engage the ratchet ring protrusion.

4. The device holder apparatus of claim 3, wherein the clip back opening plurality of tabs limit the range of rotation between the clip assembly and the device conforming body.

5. The device holder apparatus of claim 3, wherein the clip back opening plurality of tabs form a relief to the ratchet ring protrusion and the combination of the clip back opening plurality of tabs and the ratchet ring protrusion retain the orientation between the clip assembly and device conforming body until a sufficient force is exerting between the clip assembly and device conforming body.

6. The device holder apparatus of claim 3, wherein the device conforming body includes an opening adjacent the clip back opening when coupled to the clip assembly by the locking washer assembly, the device conforming body opening sized to deflect the two, separate deflectable arm inwardly while permitting the deflected arms to pass through the opening and expand to a locked state.

7. The device holder apparatus of claim 1, wherein the device conforming body includes a deflectable retaining arm for securely engaging an electronic device within the device conforming body.

8. The device holder apparatus of claim 1, wherein the clip assembly includes a deflectable retaining arm coupled to the clip back for securely engaging the clip assembly to a desired location.

9. The device holder apparatus of claim 8, wherein the desired location is a user's apparel.

10. The device holder apparatus of claim 1, wherein the device conforming body, clip assembly, and the locking washer assembly are formed substantially of a polymer.

11. A method of forming a device holder apparatus for an electronic device, comprising:
rotatably and ratchetly coupling a clip assembly to a device conforming body, the device conforming body conformable to at least a portion of an electronic device to hold the electronic device, the clip assembly for clipping to a desired location, and the locking washing assembly including:
a locking washer with two, separate deflectable arms, the separated arms forming a shaped cavity therebetween; and
a locking support having an extension having a protrusion formed in relief of the lock washer shaped cavity; and
securingly inserting the the lock support inserted into the locking washer shaped cavity to securely retain the rotatably and ratchetly coupling between the clip assembly and the device conforming body.

12. The method of forming a device holder apparatus of claim 11, wherein the locking washer assembly further includes a ratchet ring coupled over and to the locking washer two, separate deflectable arms, the ratchet ring including a protrusion.

13. The method of forming a device holder apparatus of claim 12, wherein the clip assembly includes a clip back adjacent the device conforming body when coupled to the device conforming body by the locking washer assembly, the clip back including an opening enabling the passage of the locking washer arms and ratchet ring, and the clip back opening including a plurality of tabs configured to releasably engage the ratchet ring protrusion.

14. The method of forming a device holder apparatus of claim 13, wherein the clip back opening plurality of tabs limit the range of rotation between the clip assembly and the device conforming body.

15. The method of forming a device holder apparatus of claim 13, wherein the clip back opening plurality of tabs form a relief to the ratchet ring protrusion and the combination of the clip back opening plurality of tabs and the ratchet ring protrusion retain the orientation between the clip assembly and device conforming body until a sufficient force is exerting between the clip assembly and device conforming body.

16. The method of forming a device holder apparatus of claim 13, wherein the device conforming body includes an opening adjacent the clip back opening when coupled to the clip assembly by the locking washer assembly, the device conforming body opening sized to deflect the two, separate deflectable arm inwardly while permitting the deflected arms to pass through the opening and expand to a locked state.

17. The method of forming a device holder apparatus of claim 11, wherein the device conforming body includes a deflectable retaining arm for securely engaging an electronic device within the device conforming body.

18. The method of forming a device holder apparatus of claim 11, wherein the clip assembly includes a deflectable retaining arm coupled to the clip back for securely engaging the clip assembly to a desired location.

19. The method of forming a device holder apparatus of claim 18, wherein the desired location is a user's apparel.

20. The method of forming a device holder apparatus of claim 11, wherein the device conforming body, clip assembly, and the locking washer assembly are formed substantially of a polymer.
